(19) United States
(12) Patent Application Publication
(10) Pub. No.: US 2010/0162777 A1
(43) Pub. Date: Jul. 1, 2010

(54) MOTOR VEHICLE DOOR HANDLE WITH REMOVABLE CAP FOR THE LOCK CYLINDER

(75) Inventor: Marco Savant, Alpiguano To (IT)

Correspondence Address: OSHA LIANG L.L.P., TWO HOUSTON CENTER, 909 FANNIN, SUITE 3500, HOUSTON, TX, 77010, US

(73) Assignee: VALEO S.P.A., Santena To (IT)

(21) Appl. No.: 12/377,682

(22) PCT Filed: Aug. 2, 2007
(86) PCT No.: PCT/EP07/58045

§ 371 Date: Feb. 17, 2009

(30) Foreign Application Priority Data
Aug. 25, 2006 (IT) MI2006A001643

(51) Int. Cl. E05B 65/20; E05B 1/00; E05B 17/00; E05B 17/14

(52) U.S. Cl. 70/101; 16/412

(57) ABSTRACT

A door handle for a motor vehicle that includes an elastically biased mobile grip member and a lock cylinder housing adjacent thereto, covered by a removable protective cap that is provided with a release slot formed in the side of the cap facing the grip member. The cap has an elastically deformable C-shaped cross-section and is provided with a first retention suitable to engage a second retention on the lock cylinder housing. The lock cylinder housing includes a cam surface facing the release slot and suitable to guide the tip of a key in a slightly torsional outwards motion for an easy and smooth removal of the cap.

The present invention relates to motor vehicle door handles, and in particular to a door handle provided with a removable cap to protect the lock cylinder.

It is known that a door handle is substantially made up of an elastically biased mobile member, gripped by the user, that releases the door latch and a fixed lock that prevents the operation of the latch when the door is locked.

In modern motor vehicles the door lock is usually no longer operated mechanically by a key but rather electrically by a remote control. Yet, a lock cylinder that can be operated by a key is still present for safety reasons, in fact it is necessary in case of malfunctioning of the remote control or lack of electric power in the vehicle (e.g. battery drained).

Since the use of the lock cylinder is restricted to such emergency situations, however, it is now commonly requested to hide it from view in order to obtain a more streamlined and aesthetically pleasant handle. This is achieved by means of a protective cap that hides the lock cylinder, which can be accessed by the user when required through removal or shifting of said cap.

A first known cap arrangement is disclosed in FR-A-2.753.475 that illustrates a sliding cap movable between a closed position, where the cylinder is covered, and an open position where the cylinder is accessible. The cap movement takes place in a direction substantially perpendicular to the direction of introduction of the key, namely along a longitudinal axis of the handle, and is controlled by a bistable spring that elastically returns the cap from the closed to the open position and vice versa.

Such an arrangement obviously requires sufficient room next to the handle for the sliding movement of the cap, and therefore can not be applied when the handle is not level with the outer door panel. Moreover, the presence of the spring makes the mechanism bulky and unreliable.

A simpler arrangement presently in use is to provide a snap-on cap that the user can remove by introducing the tip of the key into a release slot, so as to disengage a retention clip. In this case there is no need for further room beyond the size of the handle, and the clip can be made integral with the cap thus obtaining a compact and cheap coupling system.

Although functional, however, also this type of arrangement is not free from drawbacks both from the aesthetical and operational point of view. First of all, the presence of a visible slot is a step back with respect to the above-mentioned sliding cap that was completely closed, and therefore preferable both aesthetically and operationally since no water and/or dirt could enter the cap.

In fact, the slot is formed on the bottom side of the cap and close to the proximal edge thereof (i.e. close to the door) in order to hide it as much as possible; water and dirt coming up from the ground can enter through the slot and make the removal of the cap difficult by hindering the introduction of the key and/or the release of the retention clip.

Another drawback of this known arrangement is the risk of damaging the small and rather delicate structure of the retention clip due to an excessive effort applied by the user, which might even result in the breakage of the small portion of the cap comprised between the slot and the proximal edge thereof.

Other operational drawbacks are the risk of damaging the painted area around the slot when introducing the key and the uncomfortable position that the user must take in order to look at the slot when introducing the key.

Therefore the object of the present invention is to provide a handle which overcomes the above-mentioned drawbacks. This object is achieved by means of a handle provided with a snap-on cap that has the release slot formed in the side facing the mobile grip member and which is therefore accessible only when said grip member is pulled outwards to its operating position.

In a preferred embodiment, the cap has an elastically deformable C-shaped cross-section and first retention means formed therein suitable to engage second retention means formed on the housing of the lock cylinder, and said housing also includes a cam surface facing the release slot and suitable to guide the key tip in a slightly torsional outwards motion to make the cap removal easier.

A first important advantage of the handle according to the present invention is that it combines the aesthetic perfection of the sliding cap with the practicality of the snap-on cap, thus providing a pleasant, cheap, compact, convenient and reliable system for protecting the lock cylinder.

Other significant advantages of the present handle stemming from the position of the release slot are that the latter remains covered by the mobile grip member thus preventing the entrance of water and/or dirt, and possible damages to the painted area around the slot are not visible. Moreover, the user need not take any uncomfortable position to look at the slot when introducing the key therein, and the cap can be made with two symmetrically arranged slots so that it can be applied on both left-drive and right-drive vehicles merely by rotating it around its longitudinal axis.

Another great advantage of this handle, in its preferred embodiment, is that the cap itself acts as a retention clip thanks to its open C-shaped section, therefore there is no need to form a small and delicate clip on the inside. This results in preventing risks of damage to delicate portions of the cap, since neither a small retention clip nor a small portion of the cap comprised between the slot and the proximal edge thereof are present.

A further advantage of said preferred embodiment consists in the easy removal of the cap provided by the cam surface on the lock cylinder housing that guides the key tip to a smooth disengagement of the cap. Therefore the user need not make a particular effort and the risk of damage to the cap or other vehicle portions around it is substantially reduced.

These and other advantages and characteristics of the handle according to the present invention will be clear to those skilled in the art from the following detailed description of an embodiment thereof, with reference to the annexed drawings wherein:

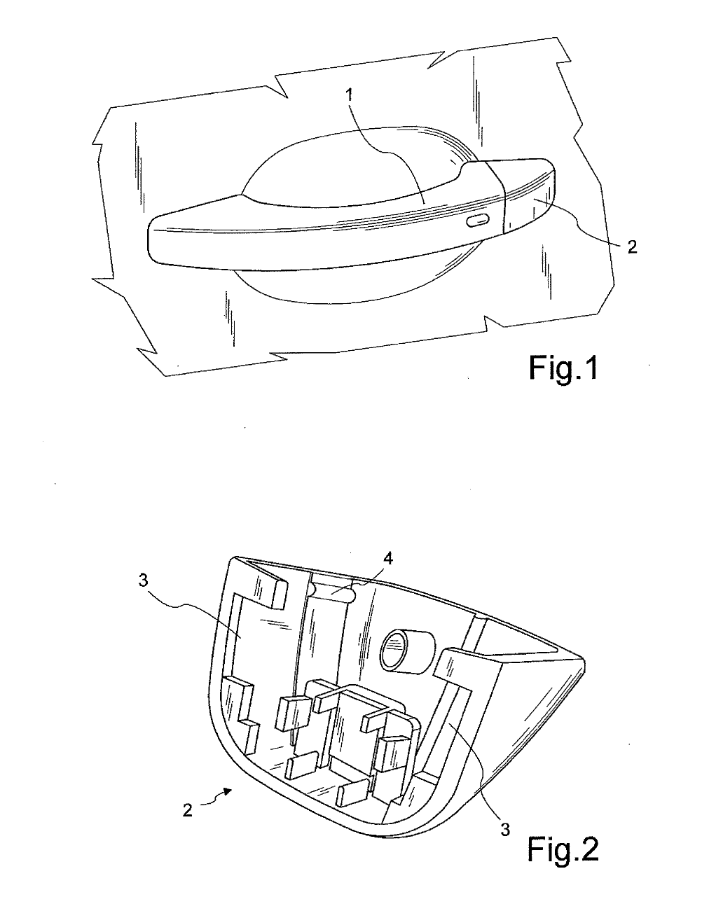

FIG. 1 is a top perspective view of the handle in the rest position;

FIG. 2 is a lateral perspective view of the cap taken from the side facing the grip member;

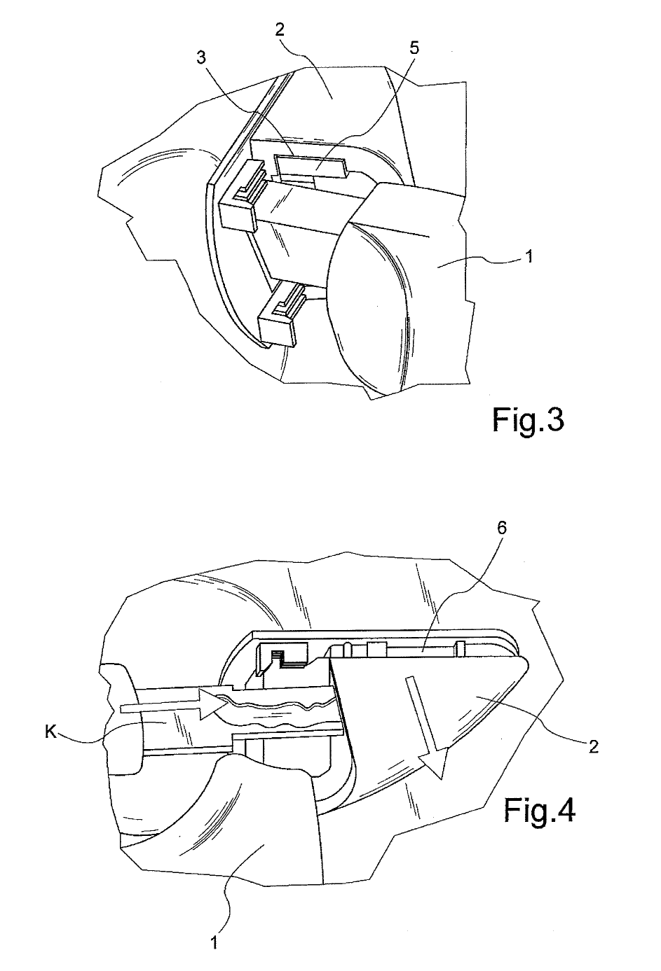

FIG. 3 is a detailed top perspective view of the handle with the grip member pulled out;

FIG. 4 is a detailed top perspective view of the cap being removed from the handle upon introduction of the key;

FIG. 5 is a detailed front view of the handle with the lock cylinder housing in view, showing the position of the key upon introduction; and

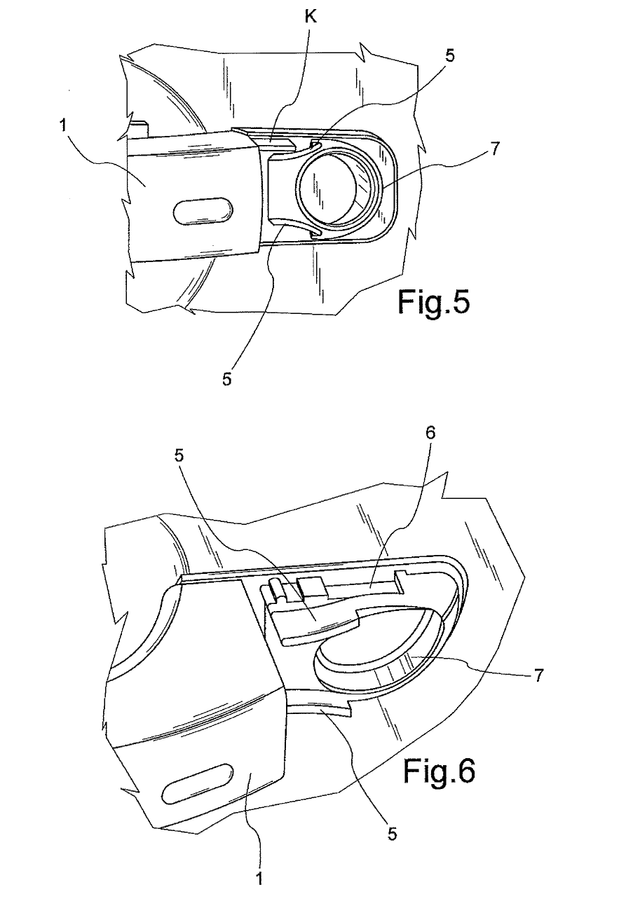

FIG. 6 is a detailed top perspective view of the handle with the lock cylinder housing in view and the grip member in the rest position.

Referring first to FIGS. 1 to 3, there is seen that a handle according to the present invention includes a mobile grip member 1, pivoted at the front end thereof, and a protective cap 2 covering the lock cylinder adjacent to the rear end of the grip member 1. In the rest position illustrated in FIG. 1, said two members 1, 2 are aligned to form a single curvilinear shape without openings that is aesthetically pleasant.

The preferred embodiment of cap 2 is illustrated in detail in FIG. 2, that clearly shows the C-shaped section of cap 2 on the side facing the grip member 1. In particular, cap 2 preferably has a symmetrical structure with respect to its longitudinal midplane; in fact it is provided with two release slots or recesses 3 formed along the short side of the C shape, and two retention lugs 4 (only one of which is visible in FIG. 2) formed internally at a substantially central position and extending in the longitudinal direction.

As clearly shown in FIG. 3, this open C-shaped side of cap 2 is partially accessible when the grip member 1 is pulled outwards to its operating position; in particular, the release slot 3 is visible and grants access to the lock cylinder housing and more specifically to the front end of a cam surface 5.

With reference also to FIGS. 4 to 6, there is seen that said cam surface 5 extends in a substantially horizontal plane and has a small upward concavity combined with a slight outward twist when moving from the front to the back. This shape of surface 5 is designed to guide the tip of a key K that is introduced into slot 3 so that said key K, under the push by the user, performs a slight torsional movement and elastically deforms cap 2 so as to disengage lug 4 from a retention seat 6 formed on the lock cylinder housing.

In this way, the user can smoothly and effortlessly achieve the removal of cap 2 through a little push on key K in the rearward longitudinal direction (as indicated in FIG. 4 by the arrows). Obviously, cap 2 can be put back in place simply by pushing it on the lock cylinder housing until the retention lugs 4 snap into the retention seats 6.

Correspondingly to cap 2, also the lock cylinder housing preferably has a symmetrical structure with respect to its longitudinal midplane, comprising two specular cam surfaces 5 and two retention seats 6 (only one of which is visible in FIGS. 4 and 6). As previously mentioned, this allows to simplify the production of the handle in that it can be applied both on left-drive and right-drive vehicles merely by rotating it through 180°.

Moreover, FIGS. 5 and 6 clearly show the compactness of the present lock protection system, with cam surfaces 5 and retention seats 6 extending substantially within the vertical size of the lock cylinder seat 7.

It is clear that the above-described and illustrated embodiment of the handle according to the invention is just an example susceptible of various modifications. In particular, the exact shape and arrangement of the retention means 4, 6 can be somewhat changed according to specific manufacturing needs, for example by providing a lug on the lock cylinder housing and a seat on cap 2, as long as the cam-driven movement of the key smoothly disengages said retention means.

1. A door handle for a motor vehicle, comprising:
an elastically biased mobile grip member; and
a lock cylinder housing adjacent to the mobile grip member, said lock cylinder housing being covered by a removable protective cap provided with at least one release slot,
wherein said at least one release slot is formed in the side of the protective cap facing said mobile grip member.

2. The door handle according to claim 1, wherein the protective cap has an elastically deformable C-shaped cross-section and is provided with first retention means formed therein suitable to engage second retention means formed on the lock cylinder housing.

3. The door handle according to claim 2, wherein the lock cylinder housing includes a cam surface facing the release slot and suitable to guide a key tip in a slightly torsional outwards motion.

4. The door handle according to claim 1, wherein the protective cap and the lock cylinder housing have structures that are symmetrical with respect to their longitudinal midplanes.
